(19) United States
(12) Patent Application Publication
(10) Pub. No.: US 2024/0100694 A1
(43) Pub. Date: Mar. 28, 2024

(54) AI-BASED CONTROL FOR ROBOTICS SYSTEMS AND APPLICATIONS

(71) Applicant: NVIDIA CORPORATION, Santa Clara, CA (US)

(72) Inventors: Ankur HANDA, Seattle, WA (US); Gavriel STATE, Toronto (CA); Arthur David ALLSHIRE, Toronto (CA); Victor MAKOVIICHUK, Santa Clara, CA (US); Aleksei Vladimirovich PETRENKO, Cupertino, CA (US)

(21) Appl. No.: 18/330,905

(22) Filed: Jun. 7, 2023

Related U.S. Application Data
(60) Provisional application No. 63/408,434, filed on Sep. 20, 2022.

(51) Int. Cl. B25J 9/16

(52) U.S. Cl. CPC B25J 9/163; B25J 9/1679

(57) ABSTRACT

Systems techniques to control a robot are described herein. In at least one embodiment, a machine learning model for controlling a robot is trained based at least on one or more population-based training operations or one or more reinforcement learning operations. Once trained, the machine learning model can be deployed and used to control a robot to perform a task.

### CLAIM OF PRIORITY

This application claims the benefit of U.S. Provisional Application No. 63/408,434 (Attorney Docket No. 22-SC1290US01) titled “Scaling Manipulation for Robotic Systems with Population Based Training,” filed Sep. 20, 2022, the entire contents of which is incorporated herein by reference.

### TECHNICAL FIELD

Embodiments of the present disclosure relate generally to computer science and robotics and, more specifically, to artificial intelligence (AI)-based control for robotics systems and applications.

### BACKGROUND

Robots are being increasingly used to perform tasks automatically in various environments. One approach for controlling a robot to perform a task is to first train a machine learning model that is then used to control the robot to perform the task. The machine learning model can be trained using training data that is generated via simulation or otherwise obtained.

One drawback of using conventional techniques to train a machine learning model to control a robot is that, oftentimes, these techniques produce unpredictable results. For example, when conventional techniques are applied to train a machine learning model to control a robot, some training runs may converge to produce a trained machine learning model faster than other training runs are able to converge. Additionally, some training runs may fail to converge entirely. Even when a training run converges to produce a trained machine learning model, that training run may not have adequately explored the large number of possible robot behaviors. As a result, the trained model learning model may not be able to control a real-world robot correctly.

As the foregoing illustrates, what is needed in the art are more effective techniques for training machine learning models to control robots.

### BRIEF DESCRIPTION OF DRAWINGS

FIG. 1 illustrates a block diagram of a system configured to implement one or more aspects of at least one embodiment;

FIG. 2 is a more detailed illustration of the machine learning server of FIG. 1, according to at least one embodiment;

FIG. 3 illustrates an approach for training robotics control agents, according to at least one embodiment;

FIG. 4 is a more detailed illustration of the reinforcement learning of FIG. 3, according to at least one embodiment;

FIGS. 5A-5C illustrate example simulation environments for training robotics control agents to control robots to perform various tasks, according to at least one embodiment;

FIG. 6 illustrates a flow diagram of a process for training robotics control agents, according to at least one embodiment;

FIG. 7 illustrates a flow diagram of a process for controlling a robot using a trained robotics control agent, according to at least one embodiment;

FIG. 8A illustrates inference and/or training logic, according to at least one embodiment;

FIG. 8B illustrates inference and/or training logic, according to at least one embodiment; and

FIG. 9 illustrates training and deployment of a neural network, according to at least one embodiment.

### DETAILED DESCRIPTION

Embodiments of the present disclosure provide improved techniques for training and using machine learning models to control robots to perform tasks. In at least one embodiment, population-based training is employed in conjunction with reinforcement learning to train machine learning models (e.g., neural networks) to control a robot to perform a task. During the training, a population of machine learning models are initialized with different parameter values, and the machine learning models are trained in parallel using different hyperparameter values. The parameter and training hyperparameter values for each machine learning model, as well as the performance of each machine learning model after training, are stored in a shared directory. After a period of time, a percentage of the worst performing machine learning models are re-initialized using the stored parameter values associated with a percentage of the best performing machine learning models. In addition, the training hyperparameter values associated with machine learning models other than the best performing machine learning models are mutated. In at least one embodiment, the training is decentralized in that the training runs for different machine learning models are not synchronized. In at least one embodiment, the training includes meta-optimization of an objective via an outer optimization loop of a population-based training technique, in addition to optimization of a reward in an inner loop of a reinforcement learning technique. After a terminating condition of the training is reached, a best performing machine learning model is chosen. The best performing model can then be deployed to control a physical robot in a real-world environment.

The techniques for training and using machine learning model(s) to control robots to perform tasks have many real-world applications. For example, those techniques could be used to control a robot to reach an object, pick up the object, manipulate the object, and/or move the object. As another example, those techniques could be used to control a robot to move (e.g., to walk or navigate) within an environment.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs) that may process textual, audio, image, and/or sensor data to generate outputs, systems for performing light transport simulation, systems for performing collaborative content creation for 3D assets, systems implemented at least partially using cloud computing resources, and/or other types of systems.

### System Overview

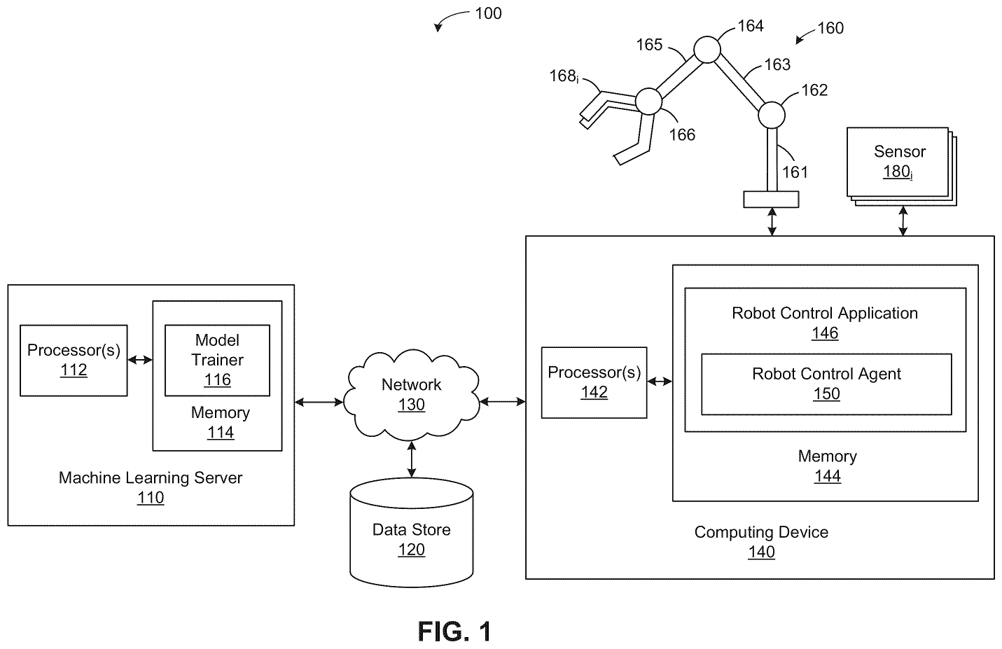

FIG. 1 illustrates a block diagram of a system 100 configured to implement one or more aspects of at least one embodiment. As shown, the system 100 includes a machine learning server 110, a data store 120, and a computing device 140 in communication over a network 130, which can be a wide area network (WAN) such as the Internet, a local area network (LAN), and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random access memory (RAM), a read-only memory (ROM), an erasable programmable read-only memory (EPROM or Flash ROM), or any suitable combination of the foregoing. In at least one embodiment, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In at least one embodiment, any combination of the processor(s) 112, the system memory 114, and/or a GPU(s) can be included in and/or replaced with any type of virtual computing system, distributed computing system, and/or cloud computing environment, such as a public, private, or a hybrid cloud system.

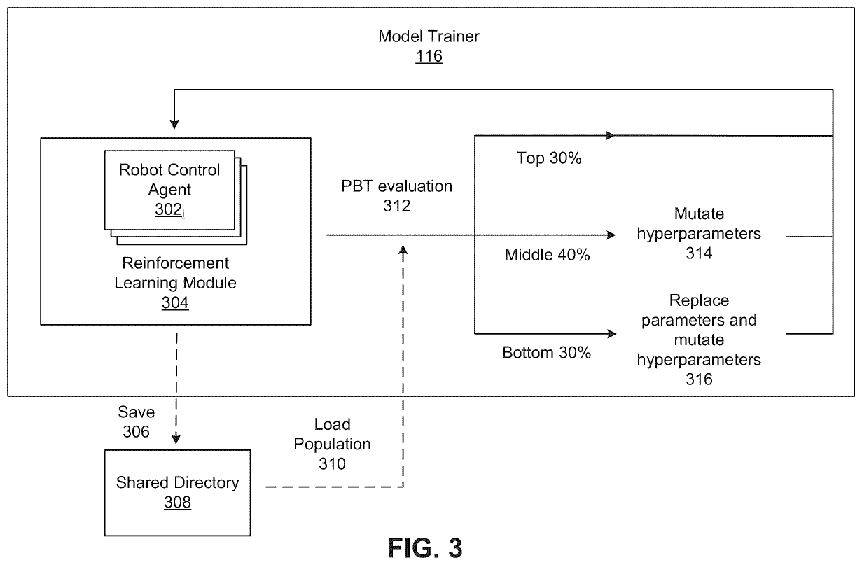

In at least one embodiment, the model trainer 116 is configured to train one or more machine learning models, including a robot control agent 150. In such cases, the robot control agent 150 is trained to generate actions for a robot to perform based on a goal and sensor data acquired via one or more sensors 180, (referred to herein collectively as sensors 180 and individually as a sensor 180). For example, in at least one embodiment, the sensors 180 can include one or more cameras, one or more RGB (red, green, blue) cameras, one or more depth (or stereo) cameras (e.g., cameras using time-of-flight sensors), one or more LiDAR (light detection and ranging) sensors, one or more RADAR sensors, one or more ultrasonic sensors, any combination thereof, etc. An architecture of the robot control agent 150, as well as techniques for training the same, are discussed in greater detail herein in conjunction with at least FIGS. 3-6. Training data and/or trained (or deployed) machine learning models, including the robot control agent 150, can be stored in the data store 120. In at least one embodiment, the data store 120 can include any storage device or devices, such as fixed disc drive(s), flash drive(s), optical storage, network attached storage (NAS), and/or a storage area-network (SAN). Although shown as accessible over the network 130, in at least one embodiment, the machine learning server 110 can include the data store 120.

As shown, a robot control application 146 that utilizes the robot control agent 150 s stored in a system memory 144, and executes on one or more processors 142, of the computing device 140. Once trained, the robot control agent 150 can be deployed, such as via robot control application 146, to control a physical robot in a real-world environment.

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168, (referred to herein collectively as fingers 168 and individually as a finger 168) that can be controlled to grip an object. For example, in at least one embodiment, the robot 160 may include a locked wrist and multiple (e.g., four) fingers. Although an example robot 160 is shown for illustrative purposes, in at least one embodiment, techniques disclosed herein can be applied to control any suitable robot.

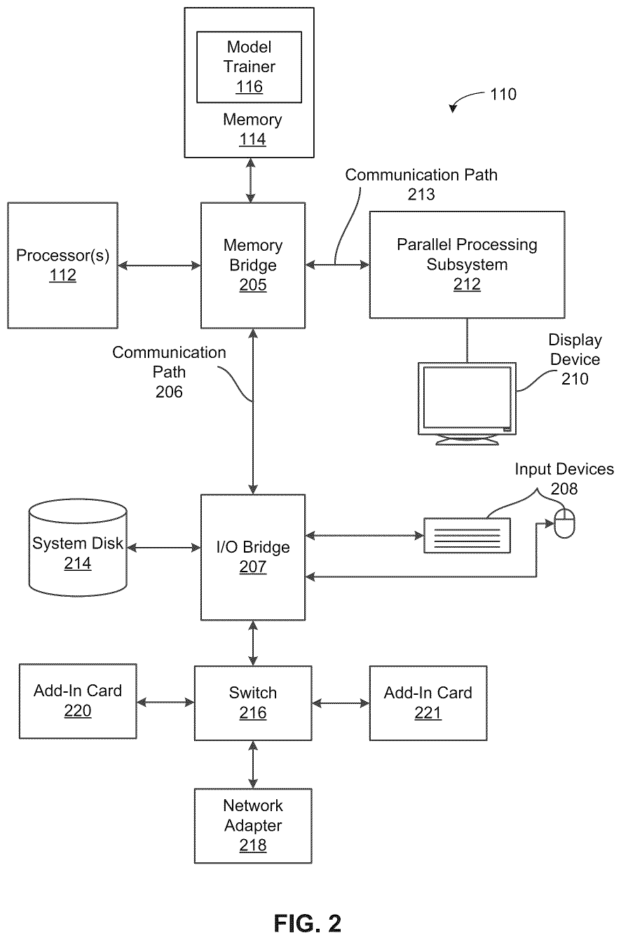

FIG. 2 is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the machine learning server 110 is a server machine operating in a data center or a cloud computing environment that provides scalable computing resources as a service over a network. In at least one embodiment, the computing device 140 can include one or more similar components as the machine learning server 110.

In various embodiments, the machine learning server 110 includes, without limitation, the processor(s) 112 and the memory(ies) 114 coupled to a parallel processing subsystem 212 via a memory bridge 205 and a communication path 213. The memory bridge 205 is further coupled to an I/O (input/output) bridge 207 via a communication path 206, and I/O bridge 207 is, in turn, coupled to a switch 216.

In one embodiment, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In at least one embodiment, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In at least one embodiment, the switch 216 is configured to provide connections between I/O bridge 207 and other components of the machine learning server 110, such as a network adapter 218 and various add-in cards 220 and 221.

In at least one embodiment, the I/O bridge 207 is coupled to a system disk 214 that may be configured to store content and applications and data for use by the processor(s) 112 and the parallel processing subsystem 212. In one embodiment, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In at least one embodiment, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. As described in greater detail herein in conjunction with at least FIGS. 2-3, such circuitry may be incorporated across one or more parallel processing units (PPUs), also referred to herein as parallel processors, included within the parallel processing subsystem 212.

In at least one embodiment, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116. Although described herein with respect to the model trainer 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 1 to form a single system. For example, the parallel processing subsystem 212 may be integrated with processor 112 and other connection circuitry on a single chip to form a system on a chip (SoC).

In at least one embodiment, the processor(s) 112 includes the primary processor of machine learning server 110, controlling and coordinating operations of other system components. In at least one embodiment, the processor(s) 112 issues commands that control the operation of PPUs. In at least one embodiment, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in at least one embodiment, system memory 114 could be connected to the processor(s) 112 directly rather than through the memory bridge 205, and other devices may communicate with the system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 1 may not be present. For example, the switch 216 could be eliminated, and the network adapter 218 and the add-in cards 220, 221 would connect directly to the I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Machine Learning Models to Control Robots

FIG. 3 illustrates an approach for training robotics control agents, according to at least one embodiment. As shown, the model trainer 116 initializes a population of robot control agents 302ᵢ (referred to herein collectively as robot control agents 302 and individually as a robot control agent 302) with different parameter values and different learning hyperparameter values. In at least one embodiment, the parameter values and the learning hyperparameter values are randomly chosen during initialization of the population of robot control agents 302.

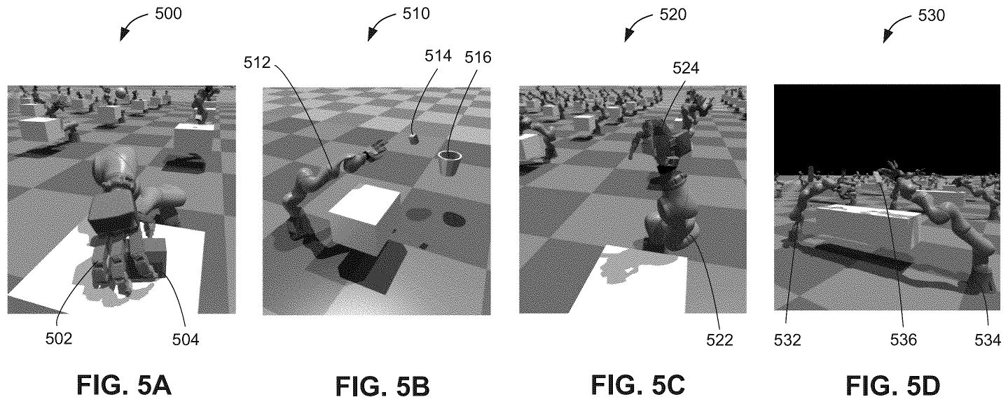

After the model trainer 116 initializes the population of robot control agents 302, a reinforcement learning module 304 trains the robot control agents 302 via a reinforcement learning technique. The robot control agents 302 can be trained to control a robot to perform any technically feasible task. Examples of such tasks include regrasping an object, grasping and throwing an object, reorienting an object, and tasks that involve multiple arms of a robot, discussed herein in conjunction with at least FIG. 5. p In at least one embodiment, the robot control agents 302 are trained to perform dexterous single-object manipulation tasks that require changing the state of a single rigid body such that the state matches a target position x∈ [symbol] ³ and, optionally, a target orientation R∈SO(3). Dexterous single-object manipulation tasks can require mastery of contact-rich grasping by a robot, as well as manipulation of the object in a hand of the robot, and dexterous single-object manipulation can be an essential primitive required to perform general-purpose rearrangement. In at least one embodiment, dexterous object manipulation tasks can be formalized as discrete-time sequential decision making processes. In such cases, at each time step, a robot control agent 302 observes an environment state sₜ∈ [symbol] ^{N}^{_{obs}} and generates an action aₜ∈ [symbol] ^{N}^{_{dof}}. For example, the action can specify the desired angles of arm and finger joints of the robot.

In at least one embodiment, a task to be performed by a robot can be modeled as a Markov Decision Process (MDP) in which a robot control agent 302 interacts with the environment to maximize the expected episodic discounted sum of rewards [symbol] [Σₜ₌₀^{T}γ^{t}r(sₜ, aₜ)]. In such cases, a proximal policy optimization (PPO) technique can be used to learn both a policy π_{θ} that is the actor (e.g., the robot control agent) and a value function V_{θ}^{π}(s) (also referred to herein as the “critic”), both of which can be parameterized by a single parameter vector θ. In at least one embodiment, the architecture of each robot control agent 302 is a long short-term memory (LSTM) neural network followed by a three-layer multilayer perceptron (MLP). In at least one embodiment, both the policy π_{θ} and the critic V_{θ}^{π}(s) observe environment state directly, such as joint angles and velocities, hand position, hand rotation, hand velocity, hand angular velocity, positions of fingertips, object keypoints relative to the hand, object keypoints relative to a goal, object rotation, object velocity, object angular velocity, and/or object dimensions. In such cases, the policy π_{θ} can output two vectors μ, σ∈ [symbol] ^{N}^{_{dof}}*^{N}^{ₐᵣₘ} that are used as parameters of N_{dof}*Nₐᵣₘ independent Gaussian probability distributions. Actions can be samples from such distributions as a˜ [symbol] (μ, σ), normalized to corresponding joint limits and interpreted as target joint angles. The actions can then be transmitted to a robot joint controller, such as a proportional derivative (PD) controller, that yields joint torques in order to move joints of a robot to the target angles specified by the policy π_{θ}.

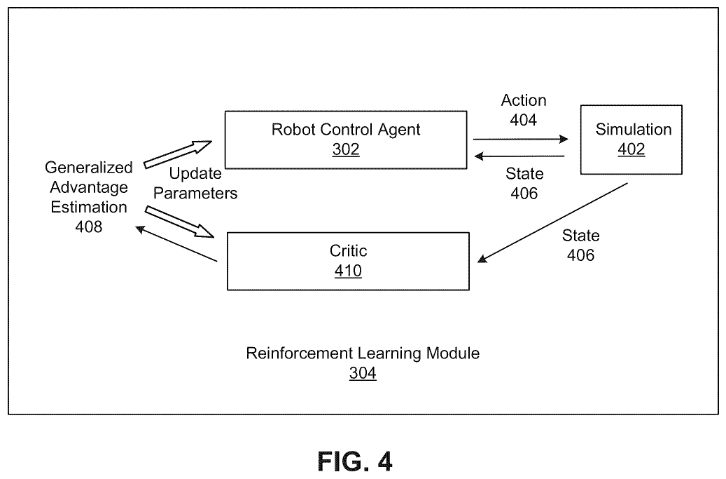

FIG. 4 is a more detailed illustration of the reinforcement learning 304 of FIG. 3, according to at least one embodiment. In at least one embodiment, the model trainer 116 trains each robot control agent using reinforcement learning and simulations of a robot in which physics parameters and/or non-physics parameters of the simulations are randomized within ranges of values. Examples of physics parameters that can be randomized include gravity, mass, scale, friction, armature, effort, joint stiffness, joint damping, and/or restitution associated with the robot and/or one or more objects that the robot interacts with. Examples of non-physics parameters that can be randomized include an object pose delay probability, an object pose frequency, an observed correlated noise, an observed uncorrelated noise, a random pose injection for an object, an action delay probability, an action latency, an action correlated noise, an action uncorrelated noise, and/or a random network adversary (RNA) α. Although one robot control agent 302 is shown for illustrative purposes, multiple robot control agents 302 can be trained in parallel in at least one embodiment. The physics parameters (e.g.,) and/or non-physics parameter randomizations are introduced into the simulation environment during training to help overcome the “sim-to-real” gap between physics simulators and real-world environments.

As shown, during a simulation 402, a sequence of actions is chained together to form a trajectory. Beginning with random trajectories in different simulations, the reinforcement learning technique trains the robot control agent 302 to learn to generate actions that can be used to achieve a goal by updating parameters of the robot control agent 302 based on whether the trajectories lead to states of the robot and/or object(s) with which the robot interacts that are closer or further from the goal, as discussed in greater detail below. Although one simulation 402 is shown for illustrative purposes, in at least one embodiment, multiple simulations can be performed in parallel. For example, in at least one embodiment, the model trainer 116 can train the policy using experience simulated in a highly parallelized GPU-accelerated physics simulator. In such cases, to process the high volume of data generated by the physics-based simulator, the model trainer 116 can use an efficient PPO implementation to keep the computation graph entirely on GPU(s). Combined with an appropriate minibatch size (e.g., 2¹⁵ transitions), the hardware utilization and learning throughput can be maximized. Observations, advantages and temporal difference (TD)-returns can be normalized in at least one embodiment to make the training invariant to the absolute scale of observations and rewards. In addition, in at least one embodiment, the model trainer 116 employs an adaptive learning rate technique to maintain a constant Kullback-Liebler (KL) divergence between the trained policy π_{θ} and the behavior policy π_{θ}_{_{old}} that collect rollouts. Some robot tasks, such as regrasping and reorientation of objects, can require relatively precise control (e.g., that the keypoints be within the final tolerance ϵ*=1 cm of the target). In order to create a smooth learning curriculum, in at least one embodiment, the model trainer 116 adaptively anneals the tolerance annealed from a larger initial value (e.g., ϵ₀=7.5 cm). In such cases, the model trainer 116 periodically checks if the policy crosses a performance threshold (e.g., N_{succ}>3), in which case the current success tolerance can be decreased (e.g., ϵ←0.9ϵ) until the success tolerance reaches a final value.

During each iteration of reinforcement learning, the model trainer 116 updates parameters of a robot control agent 302 and a critic 410 that is trained along with the robot control agent 302. As described, the critic 410 is a neural network that approximates an estimated value function, which is used to criticize actions generated by the robot control agent 302. Illustratively, after the robot control agent 302 generates an action 404 that is performed by a robot in the simulation 402, the critic 410 computes a generalized advantage estimation based on (1) a new state 406 of the robot and/or an object that the robot interacts with, and (2) a reward function. The generalized advantage estimation indicates whether the new state 406 is better or worse than expected, and the model trainer 116 updates the parameters of the robot control agent 302 such that the robot control agent 302 is more or less likely to generate the action 404 based on whether the new state 406 is better or worse, respectively.

In at least one embodiment, any technically feasible reward function can be used in computing the generalized advantage estimation, and the reward function that is used will generally depend on the type of robot and the task to be performed by the robot. In at least one embodiment, the reward is dense enough to facilitate exploration of possible robot behaviors, yet does not distract the robot control agent from the sparse final objective (e.g., a number of consecutive successful manipulations of an object). In at least one embodiment, when the task includes a robot interacting with an object, the reward function can include one or more terms associated with reaching the object, picking up the object, and/or moving the object closer to a target state. In such cases, higher reward function values can correspond to solving the robot task, and vice versa, and the reinforcement learning attempts to maximize the reward function. More formally, in such cases, a reward function that naturally guides a robot control agent through a sequence of motions required to complete a task, from reaching for an object to picking up the object to moving the object to a final location, can have the form:

r(s, a)=r_{reach}(s)+r_{pick}(s)+r_{targ}(s)−rᵥₑₗ(a). (1)

In equation (1), r_{reach}(s) rewards the robot control agent for moving a robot hand closer to the object at the start of an attempt:

r_{reach}(s)=α_{reach}*max(d_{closest}−d, 0), (2)

where both d and d_{closest} are distances between the end effector of the robot and the object, d is the current distance, and d_{closest} is the closest distance achieved during the attempt so far.

In equation (1), r_{pick}(s) rewards the robot control agent for picking up an object and lifting the object, such as off of a table:

r_{pick}(s)=(1−1_{picked})*α_{pick}*hₜ+r_{picked}, (3)

where 1_{picked} is an indicator function that becomes 1 once the height of the object relative to a table hₜ exceeds a predefined threshold. When the height exceeds the predefined threshold, the robot control agent receives an additional sparse reward r_{picked}. Once the object is picked up, r_{targ} in equation (1) rewards the robot control agent for moving the object closer to a target state:

r_{targ}(s)=1_{picked}*α_{targ}*max(\hat{d}_{closest}−\hat{d}, 0)+r_{success}, (4)

where \hat{d} is the maximum distance between corresponding pairs of object and target keypoints, and \hat{d}_{closest} is the closest such distance achieved during the attempt so far. A large sparse reward r_{success} is added when all of the Nₖₚ keypoints associated with an object are within a tolerance threshold of their target locations, meaning that reposing and/or reorientation of the object is complete. Finally, rᵥₑₗ in equation (1) is a joint velocity penalty that can be tuned to promote smoother movement, and the constants α_{reach}, α_{pick}, and α_{targ} in equations (2), (3), and (4), respectively, are relative reward weights. It should be noted that, in at least one embodiment, the exact same reward function can be applied in all scenarios. In addition, the reward formulation of equations (1)-(4) follows a sequential pattern: the reward components r_{reach}(s), r_{pick}(s), and r_{targ}(s) are mutually exclusive and do not interfere with each other. For example, by the time a robot hand approaches an object, the component r_{reach}(s) is exhausted since d=d_{closest}=0, so r_{reach} does not contribute to the reward for the remainder of the trajectory. Likewise, r_{pick}≠0 if and only if r_{targ}=0, and vice versa. The fact that only one major reward component guides the motion at each stage of the trajectory makes tuning of the rewards and avoiding interference between reward components easier. As a result, many possible local minima can be avoided during training: for example, if r_{pick} and r_{targ} are applied together, depending on the relative reward magnitudes, the robot control agent can choose to slide the object to the edge of a table closer to the target location and cease further attempts to pick up the object and get closer to the target for fear of dropping the object. In addition, the rewards in equations (2) and (4) have a predefined maximum total value depending on the initial distance between the robot hand and the object, and the object and the target, respectively. The predefined maximum total value eliminates reward hacking behaviors where a robot control agent remains close but not quite at a goal to keep collecting the proximity reward, because only movement towards the goal is rewarded, while mere proximity to the goal is not.

Returning to FIG. 3, in addition to optimizing the reward of equation (1) in an inner loop of the reinforcement learning 304, in at least one embodiment, the model trainer 116 further performs a population-based training technique that includes meta-optimization of an objective via an outer optimization loop. In such cases, the population-based training technique permits improved exploration of the large number of possible robot behaviors, which can produce higher performance trained robot control agents after convergence relative to conventional training techniques that, as described above, can be highly unpredictable. In addition, the population-based training technique can automatically tune hyperparameters used during training. More formally, in at least one embodiment, the population-based training technique trains a population of agents [symbol] , performs mutation to generate promising hyperparameter combinations, and uses selection to prioritize agents with the best performance. In at least one embodiment, each agent (θᵢ, pᵢ)∈ [symbol] is associated with (1) a parameter vector θᵢ, which can specify neural network weights, and (2) and a set of learning hyperparameters pᵢ, which includes settings of the reinforcement learning technique as well as reward coefficients α_{reach}, α_{pick}, α_{picked}, α_{targ}, and r_{success}. More specifically, the hyperparameters can include a discount factor γ, a generalized advantage estimate (GAE) discount λ, a learning rate, an adaptive learning rate D_{KL}(π|π_{old}), a gradient norm, a pro-clip ϵ, a critical loss coefficient, an entropy coefficient, a number of agents, a minibatch size, a rollout length, and/or a number of epochs per iteration, etc. By initializing the population of robot control agents with different random parameter values and learning hyperparameter values, and then communicating information from the best training runs to other training runs, each training run can benefit from the best performing training runs, thereby minimizing the discrepancy and variance across training runs. In at least one embodiment, information can be communicated from the best training runs to other training runs by periodically (1) reinitializing a percentage of the worst performing machine learning models using the stored parameter values associated with a percentage of the best performing machine learning models, and (2) mutating the training hyperparameter values associated with machine learning models other than the best performing machine learning models, as discussed in greater detail below. To induce diversity and ensure that the population of robot control agents do not all become copies of the best performing robot control agents, the simulations of the robot control agents, including after information from the best training runs is communicated to the other training runs, can be established with different parameters and initial conditions, such as randomized physics parameters and/or non-physics parameters and random sampling of actions, described above.

As described, the population-based training technique also introduces an outer optimization loop, which can be used to meta-optimize an objective function such as a final sparse scalar objective, as opposed to the inner reinforcement learning loop, which can balance various dense reward components. In at least one embodiment, the population-based training technique optimizes the following meta-optimization objective:

$$\{ \begin{matrix}{r}_{meta} = \frac{{ϵ}_{0} - ϵ}{{ϵ}_{0} - {ϵ}^{*}} + 0.1 * {N}_{succ} & if ϵ > {ϵ}^{*} \\ {r}_{meta} = 1 + {N}_{succ} & if ϵ = {ϵ}^{*}\end{matrix} , \qquad ( 5 )$$

where N_{succ} is a number of consecutive successful performances of a task and ϵ* is a target tolerance. Until the target tolerance ϵ* is reached, the objective of equation (5) is dominated by the term

$$\frac{{ϵ}_{0} - ϵ}{{ϵ}_{0} - {ϵ}^{*}} .$$

After the target tolerance ϵ* is reached, N_{succ} is prioritized in the objective of equation (5). In at least one embodiment, the combination of the population-based training technique and the reinforcement learning technique can be implemented according to Algorithm 1.

Algorithm 1

Require: [symbol] (initial population, θ, p sampled randomly)

| 1: | for (0, p) ∈ [symbol] do (async, and decentralized) | |
|---|---|---|
| 2: | while not end of training do | |
| 3: | θ ← train(θ, p) | [symbol] Do RL for Nᵢₜₑᵣ steps |
| 4: | N_{succ} ← eval(θ) | |
| 5: | (θ*, p*)~ [symbol] ₜₒₚ ⊂ [symbol] | [symbol] Get agent from top 30% |
| 6: | if N_{succ} in bottom 30% of [symbol] then | |
| 7: | p ← mutate(p, p*) | |
| 8: | θ ← θ* | [symbol] Replace weights |
| 9: | else if N_{succ} not in [symbol] ₜₒₚ then | |
| 10: | p ← mutate(p) | |
| 11: | end if | |
| 12: | end while | |
| 13: | end for | |
| 14: | return θ_{best} ∈ [symbol] | [symbol] Agent θ with the highest N_{succ} |

An example combination of the population-based training technique and the reinforcement learning technique is shown in FIG. 3. Illustratively, after each robot control agent 302 is trained via reinforcement learning 304 for a given number of iterations, the model trainer 116 evaluates how well the robot control agents 302 can control a robot to perform a task using the meta-optimization objective of equation (5). In addition, the model trainer 116 saves the parameter values of each robot control agent 302, training hyperparameters values used to train each robot control agent 302, and the performance of each robot control agent 302, to a shared directory 308.

In at least one embodiment, training of the robot control agents 302 is decentralized in that the training runs of different robot control agents 302 are not synchronized by a central orchestrator, which is typically required in conventional population-based training approaches. For example, in at least one embodiment, training jobs associated with the robot control agents 302 are queued for execution on a computing system (e.g., a computer cluster), and the training jobs can execute at different times. Regardless of when the training job for a particular robot control agent 302 executes, after the robot control agent 302 is trained for a given number of iterations, the model trainer 116 evaluates how well the robot control agent 302 performs and saves the performance of the robot control agent 302 to the shared directory 308. In particular, in at least one embodiment, agents in the population of robot control agents [symbol] interact through low-bandwidth access to a shared network directory storing histories of checkpoints and performance metrics for each robot control agent. The lack of any central orchestrator not only removes a point of failure, but also allows training to be performed in volatile compute environments, such as a contested cluster in which jobs can be interrupted or remain in queue for a long time. It should be noted that robot control agents that start training at a later time can be disadvantaged compared to other members of the population of robot control agents that started training earlier. To mitigate such a disadvantage, in at least one embodiment, the model trainer 116 compares performance of robot control agents that started later only to historical checkpoints of other agents that correspond to the same amount of collected experience.

Illustratively, after a period of time, the model trainer 116 (1) re-initializes a percentage of the worst performing robot control agents 302 by replacing the parameter values of those worst performing robot control agents 302 with the parameter values associated with a percentage of the best performing robot control agents 302, and (2) mutates the training hyperparameter values associated with robot control agents 302 other than the best performing robot control agents 302. As shown, the model trainer 116 loads, from the shared directory 308, the saved performance information of the robot control agents 302 at 310. Then, the model trainer 116 performs a population-based training evaluation at 312 to determine the top 30%, middle 40%, and bottom 30% of robot control agents 302 in terms of performance. Although the top 30%, middle 40%, and bottom 30% are described herein as a reference example, any suitable percentages of top performing, bottom performing, and middle performing machine learning models can be used in at least one embodiment. The model trainer 116 re-initializes the bottom performing robot control agents 302 by replacing the parameter values of each robot control agent 302 in the bottom 30% with the parameter values of one of the robot control agents 302 in the top 30% at 316. In addition, at 316, the model trainer 116 mutates the training hyperparameters used to train the bottom 30% of robot control agents 302 based on the training hyperparameters used to train the top 30% of robot control agents 302. For the middle 40% of robot control agents 302, the model trainer 116 mutates the training hyperparameters used to train the middle 40% of robot control agents 302 at 314. After updating the parameters and the training hyperparameters associated with the bottom 30% of robot control agents 302 and the training hyperparameters associated with the middle 40% of robot control agents, the model trainer 116 trains the robot control agents 302 again using the reinforcement learning technique, until a terminating condition, such as performance criteria or a maximum number of training iterations, is reached.

After the terminating condition of the training is reached, the model trainer 116 selects a best performing robot control agent 302, as indicated by the saved performance of the robot control agents 302 in the shared directory 308. Thereafter, the best performing robot control agent 302 can be deployed (e.g., as the robot control agent 150) to control a physical robot in a real-world environment.

FIGS. 5A-5C illustrate example simulation environments for training robotics control agents to control robots to perform various tasks, according to at least one embodiment. For example, the simulation environments can be used in the training simulations 402, described herein in conjunction with at least FIG. 4. As shown in FIG. 5A, using a simulation environment 500, robot control agents can be trained to control a robot (e.g., robot 502) to perform a regrasping task. In at least one embodiment, the regrasping task includes grasping an object (e.g., object 504), picking up the object from a table, and holding the object in a specified location for a duration of time. To succeed at the regrasping task, a robot control agent needs to learn to control a robot with stable grasps that minimize the probability of dropping the object. In at least one embodiment, robot control agents can be trained to perform a regrasping task using the population-based training and reinforcement learning techniques described herein in conjunction with FIGS. 3-4 and 6.

As shown in FIG. 5B, using a simulation environment 510, robot control agents can be trained to control a robot (e.g., robot 512) to perform a grasp-and-throw task. In at least one embodiment, the grasp-and-throw task includes grasping an object (e.g., object 514), picking up the object, and displacing the object into a container (e.g., container 516), which in some cases can include aiming for the container and throwing the object a significant distance. To succeed at the grasp-and-throw task, a robot control agent needs to learn to control a robot to release the grip of the object at the right point of the trajectory, giving the object the right amount of momentum to direct the object towards the goal of the container. In at least one embodiment, robot control agents can be trained to perform a grasp-and-throw task using the population-based training and reinforcement learning techniques described herein in conjunction with FIGS. 3-4 and 6.

As shown in FIG. 5C, using an environment 500, robot control agents can be trained to control a robot (shown as robot 522) to perform a reorientation task. In at least one embodiment, the reorientation task includes grasping an object and consecutively moving the object to different target positions and orientations. To succeed at the reorientation task, a robot control agent needs to learn (1) to control a robot to maintain a stable grip of the object for minutes of simulated time, (2) fine control of the joints of a robotic arm, and (3) occasionally, in-hand rotation of the object when reorientation of the object cannot be performed without in-hand rotation. In at least one embodiment, robot control agents can be trained to perform a reorientation task using the population-based training and reinforcement learning techniques described herein in conjunction with FIGS. 3-4 and 6.

In at least one embodiment, the regrasping and reorientation tasks, described herein in conjunction with at least FIGS. 5A and 5C, require a number of keypoints associated with the object that is being regrasped or reoriented to be within a final tolerance of a target. For example, when the object is a cube, the keypoints may be corners of the cube that need to be within a tolerance of a target. In at least one embodiment, robot control agents for controlling a robot to perform the regrasping, grasp-and-throw, and reorientation tasks, described herein in conjunction with at least FIGS. 5A-5C, can be trained and tested on target objects with randomized proportions, such as objects having various sizes from small to large and various shapes (e.g., from cubes to highly elongated parallelepipeds). Using a multitude of different objects during training can reduce the chance of overfitting to any particular object shape and size.

As shown in FIG. 5D, using an environment 500, robot control agents can be trained to control two robots (shown as robot 532 and 534) to perform a dual-arm task. In at least one embodiment, the dual-arm task includes grasping an object, passing the object from one hand of the robot to another hand of the robot, and in-hand manipulation of the object. In at least one embodiment, the observation and action space (aₜ∈ [symbol] ^{2N}^{_{dof}}) are both extended to permit a single robot control agent to control both arms of a robot. In at least one embodiment, robot control agents can be trained to perform a dual-arm task using the population-based training and reinforcement learning techniques described herein in conjunction with FIGS. 3-4 and 6.

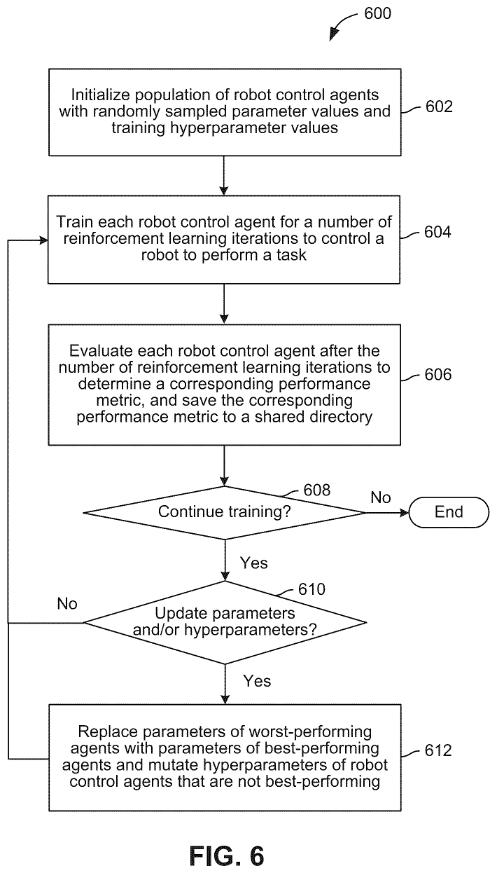

FIG. 6 illustrates a flow diagram of a process 600 for training robotics control agents, according to at least one embodiment. Although the process is described in conjunction with the systems of FIGS. 1-2, persons skilled in the art will understand that any system configured to perform the process in any order falls within the scope of the present embodiments.

As shown, the process 600 begins at operation 602, where the model trainer 116 initializes a population of robot control agents with randomly sampled parameter values and training hyperparameter values. In at least one embodiment, the population of robot control agents can include any suitable number of robot control agents.

At operation 604, the model trainer 116 trains each robot control agent to control a robot to perform a task for a number of reinforcement learning iterations using the parameter values and training hyperparameter values determined at process 600. In at least one embodiment, the model trainer 116 can perform the reinforcement learning technique described herein in conjunction with at least FIG. 4 to train the robot control agents.

At operation 606, the model trainer 116 evaluates each robot control agent after the number of reinforcement learning iterations to determine a corresponding performance metric, and model trainer 116 saves the corresponding performance metric to a shared directory. In at least one embodiment, the performance metric is a number of times that the robot control agent succeeded in performing the task for which the robot control agents were trained at operation 604. In at least one embodiment, the model trainer 116 can also save the parameter values and training hyperparameter values associated with each robot control agent to the shared directory.

If the model trainer 116 determines to continue training at operation 608, then the process 600 continues to operation 610, where the model trainer 116 determines whether to update the robot control agent parameters and/or the training hyperparameters. In at least one embodiment, the model trainer 116 updates the robot control agent parameters and/or the training hyperparameters periodically.

If the model trainer 116 determines not to update the robot control agent parameters and/or the training hyperparameters, then the process 600 returns to operation 604, where the model trainer 116 continues training the robot control agents to control the robot to perform the task. On the other hand, if the model trainer 116 determines to update the robot control agent parameters and/or the agent hyperparameters, then the process 600 continues to operation 612. At operation 612, the model trainer 116 replaces the parameters of a percentage of the worst performing agents with parameters of a percentage of the best performing agents and mutates the training hyperparameters associated with robot control agents that are not in the percentage of best performing robot control agents. Thereafter, the process 600 returns to operation 604, where the model trainer 116 again trains each robot control agent to control the robot to perform the task for a number of reinforcement learning iterations.

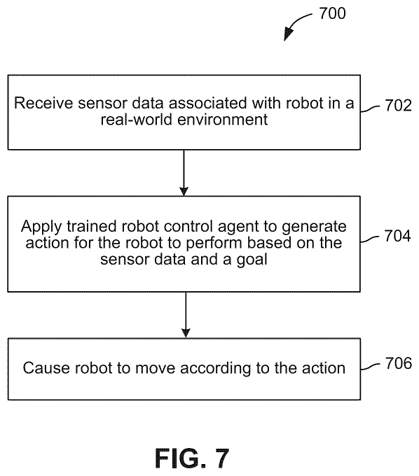

FIG. 7 illustrates a flow diagram of a process 700 for controlling a robot using a trained robotics control agent, according to at least one embodiment. Although the process is described in conjunction with the systems of FIGS. 1-2, persons skilled in the art will understand that any system configured to perform the process in any order falls within the scope of the present embodiments.

As shown, the process 700 begins at operation 702, where the robot control application 146 receives sensor data associated with a robot in a real-world environment. In at least one embodiment, the sensor data can include images captured by one or more RGB cameras that are mounted on the robot and/or elsewhere in the environment. In at least one embodiment, the robot is interacting with one or more objects in the captured images.

At operation 704, the robot control application 146 applies a trained robot control agent (e.g., robot control agent 150) to generate an action for the robot to perform based on the sensor data and a goal. In at least one embodiment, the action includes joint angles to be achieved by joints of the robot. In at least one embodiment, the trained robot control agent can be trained according to the process 600, described herein in conjunction with at least FIG. 6.

At operation 706, the robot control application 146 causes the robot to move according to the action generated at operation 704. For example, in at least one embodiment, the robot control application 146 can transmit the action to a joint controller of the robot in order to cause the robot to move according to the action, as described herein in conjunction with at least FIG. 3.

At least one technical advantage of the disclosed techniques relative to the prior art is that, with the disclosed techniques, machine learning models can be successfully trained to control robots to perform tasks. In addition, relative to prior art approaches, the disclosed techniques are able to better explore possible robot behaviors to produce a trained model learning model that can control a real-world robot correctly. For example, the disclosed techniques permit a machine learning model to be trained to control a robot that includes a high degree of freedom hand-arm system to perform grasping and dexterous in-hand manipulation of an object. These technical advantages represent one or more technological improvements over prior art approaches.

### Inference and Training Logic

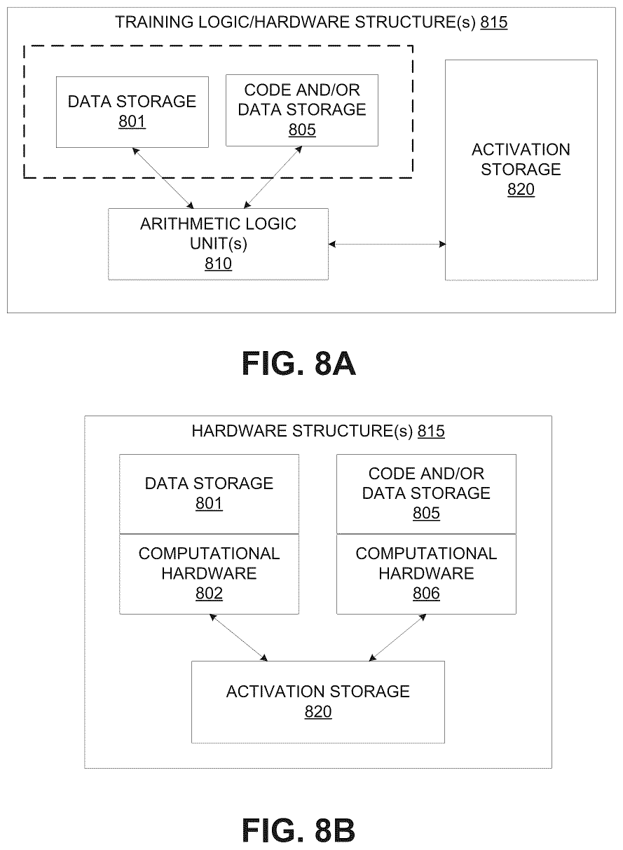

FIG. 8A illustrates inference and/or training logic 815 used to perform inferencing and/or training operations associated with one or more embodiments. Details regarding inference and/or training logic 815 are provided below in conjunction with at least FIGS. 8A and/or 8B.

In at least one embodiment, inference and/or training logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 801 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to one or more processors or other hardware logic devices or circuits. In at least one embodiment, code and/or data storage 805 may be cache memory, DRAM, SRAM, non-volatile memory (e.g., flash memory), or other storage. In at least one embodiment, a choice of whether code and/or data storage 805 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be a combined storage structure. In at least one embodiment, code and/or data storage 801 and code and/or data storage 805 may be partially combined and partially separate. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., flash memory), or other storage. In at least one embodiment, activation storage 820 may be completely or partially within or external to one or more processors or other logical circuits. In at least one embodiment, a choice of whether activation storage 820 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 illustrated in FIG. 8A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one embodiment. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one storage/computational pair 801/802 of code and/or data storage 801 and computational hardware 802 is provided as an input to a next storage/computational pair 805/806 of code and/or data storage 805 and computational hardware 806, in order to mirror a conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage/computation pairs 801/802 and 805/806 may be included in inference and/or training logic 815.

### Neural Network Training and Deployment

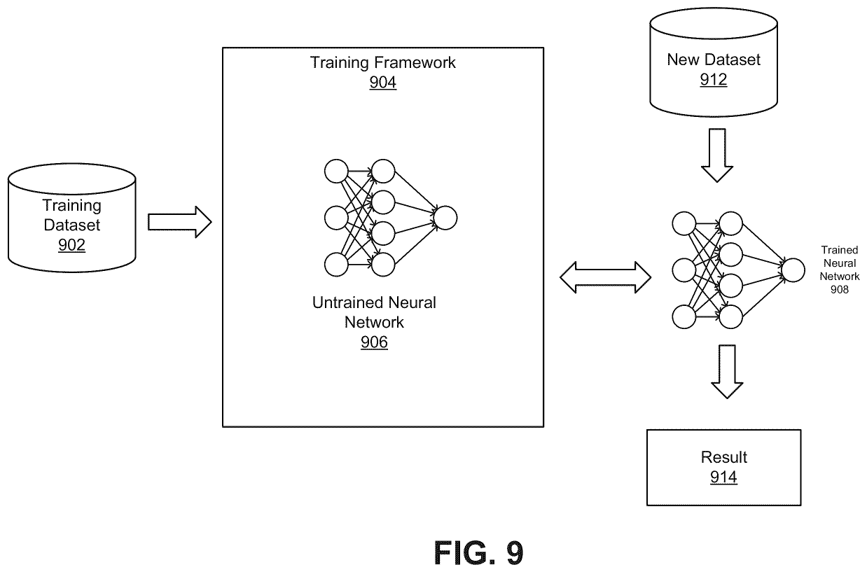

FIG. 9 illustrates training and deployment of a deep neural network, according to at least one embodiment. In at least one embodiment, untrained neural network 906 is trained using a training dataset 902. In at least one embodiment, training framework 904 is a PyTorch framework, whereas in other embodiments, training framework 904 is a TensorFlow, Boost, Caffe, Microsoft Cognitive Toolkit/CNTK, MXNet, Chainer, Keras, Deeplearning4j, or other training framework. In at least one embodiment, training framework 904 trains an untrained neural network 906 and enables it to be trained using processing resources described herein to generate a trained neural network 908. In at least one embodiment, weights may be chosen randomly or by pre-training using a deep belief network. In at least one embodiment, training may be performed in either a supervised, partially supervised, or unsupervised manner.

In at least one embodiment, untrained neural network 906 is trained using supervised learning, wherein training dataset 902 includes an input paired with a desired output for an input, or where training dataset 902 includes input having a known output and an output of neural network 906 is manually graded. In at least one embodiment, untrained neural network 906 is trained in a supervised manner and processes inputs from training dataset 902 and compares resulting outputs against a set of expected or desired outputs. In at least one embodiment, errors are then propagated back through untrained neural network 906. In at least one embodiment, training framework 904 adjusts weights that control untrained neural network 906. In at least one embodiment, training framework 904 includes tools to monitor how well untrained neural network 906 is converging towards a model, such as trained neural network 908, suitable to generating correct answers, such as in result 914, based on input data such as a new dataset 912. In at least one embodiment, training framework 904 trains untrained neural network 906 repeatedly while adjust weights to refine an output of untrained neural network 906 using a loss function and adjustment algorithm, such as stochastic gradient descent. In at least one embodiment, training framework 904 trains untrained neural network 906 until untrained neural network 906 achieves a desired accuracy. In at least one embodiment, trained neural network 908 can then be deployed to implement any number of machine learning operations.

In at least one embodiment, untrained neural network 906 is trained using unsupervised learning, wherein untrained neural network 906 attempts to train itself using unlabeled data. In at least one embodiment, unsupervised learning training dataset 902 will include input data without any associated output data or “ground truth” data. In at least one embodiment, untrained neural network 906 can learn groupings within training dataset 902 and can determine how individual inputs are related to untrained dataset 902. In at least one embodiment, unsupervised training can be used to generate a self-organizing map in trained neural network 908 capable of performing operations useful in reducing dimensionality of new dataset 912. In at least one embodiment, unsupervised training can also be used to perform anomaly detection, which allows identification of data points in new dataset 912 that deviate from normal patterns of new dataset 912.

In at least one embodiment, semi-supervised learning may be used, which is a technique in which in training dataset 902 includes a mix of labeled and unlabeled data. In at least one embodiment, training framework 904 may be used to perform incremental learning, such as through transferred learning techniques. In at least one embodiment, incremental learning enables trained neural network 908 to adapt to new dataset 912 without forgetting knowledge instilled within trained neural network 908 during initial training.

In at least one embodiment, training framework 904 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.
1. In some embodiments, a method comprises performing one or more operations to train a plurality of machine learning models to control at least a portion of a robot to perform a task, updating at least one first value of at least one parameter or at least one hyperparameter associated with one or more first machine learning models included in the plurality of machine learning models based at least on at least one second value of the at least one parameter or the at least one hyperparameter associated with one or more second machine learning models included in the plurality of machine learning models, and subsequent to the updating, performing one or more additional operations to train the plurality of machine learning models to control at least the portion of the robot to perform the task.
2. The method of clause 1, wherein the one or more first machine learning models include a predefined percentage of worst performing machine learning models in the plurality of machine learning models, and the one or more second machine learning models include a predefined percentage of best performing machine learning models in the plurality of machine learning model.
3. The method of clauses 1 or 2, wherein the one or more first machine learning models include a predefined percentage of machine learning models in the plurality of machine learning models whose performance is neither worst nor best in the plurality of machine learning models, and the one or more first machine learning models include a predefined percentage of best performing machine learning models in the plurality of machine learning models.
4. The method of any of clauses 1-3, wherein the updating the at least one first value of the at least one parameter or the at least one hyperparameter associated with the one or more first machine learning models comprises replacing the at least one value of the at least one parameter or the at least one hyperparameter associated with the one or more first machine learning models with the at least one second value of the at least one parameter or the at least one hyperparameter associated with the one or more second machine learning models.
5. The method of any of clauses 1-4, wherein the one or more operations to train the plurality of machine learning models comprise one or more reinforcement learning operations.
6. The method of any of clauses 1-5, wherein the one or more operations to train the plurality of machine learning models are based at least on a reward associated with at least one of reaching an object, picking up the object, or bringing the object to a location.
7. The method of any of clauses 1-6, wherein the one or more operations to train the plurality of machine learning models are based at least on meta-optimization of an objective.
8. The method of any of clauses 1-7, wherein the performing the one or more operations to train the plurality of machine learning models comprises performing one or more operations to train a third machine learning model included in the plurality of machine learning models, and performing one or more operations to train a fourth machine learning model included in the plurality of machine learning models, wherein the one or more operations to train the third machine learning model begin at a different time than the one or more operations to train the fourth machine learning model.
9. The method of any of clauses 1-8, further comprising, subsequent to the performing the one or more additional operations selecting a third machine learning model included in the plurality of machine learning models based on a performance of the third machine learning model, and performing one or more operations to control at least the portion of the robot to perform the task using the third machine learning model.
10. The method of any of clauses 1-9, wherein the task includes at least one of regrasping an object, throwing an object, or reorienting an object with one or two arms of the robot.
11. The method of any of clauses 1-10, wherein the method is performed by a processor comprised in at least one of an infotainment system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using the robot, a system for generating or presenting virtual reality, augmented reality, or mixed reality content, a system for performing conversational AI operations, a system implementing one or more large language models (LLMs), a system for generating synthetic data, a system incorporating one or more virtual machines (VMs), a system implemented at least partially in a data center, or a system implemented at least partially using cloud computing resources.
12. In some embodiments, a method comprises receiving sensor data associated with a robot, generating an action based at least on the sensor data and a first machine learning model, and controlling at least a portion of the robot to perform a task based on the action, wherein the first machine learning model was trained by performing one or more operations to train a plurality of machine learning models to control at least the portion of the robot to perform the task, updating at least one first value of at least one parameter or at least one hyperparameter associated with one or more second machine learning models included in the plurality of machine learning models based at least on at least one second value of the at least one parameter or the at least one hyperparameter associated with one or more third machine learning models included in the plurality of machine learning models, subsequent to the updating, performing one or more additional operations to train the plurality of machine learning models to control at least the portion of the robot to perform the task, and selecting the first machine learning model from the plurality of machine learning models.
13. The method of clause 12, wherein the one or more second machine learning models include a predefined percentage of worst performing machine learning models in the plurality of machine learning models, and the one or more third machine learning models include a predefined percentage of best performing machine learning models in the plurality of machine learning models.
14. The method of clauses 12 or 13, wherein the one or more operations to train the plurality of machine learning models comprise one or more reinforcement learning operations.
15. The method of any of clauses 12-14, wherein the performing the one or more operations to train the plurality of machine learning models comprises performing one or more operations to simulate the robot in a plurality of simulations, and the plurality of simulations are performed in parallel via one or more graphics processing units (GPUs).
16. The method of any of clauses 12-15, wherein the one or more operations to train the plurality of machine learning models are based at least on at least one of meta-optimization of an objective or optimization of a reward associated with at least one of reaching an object, picking up the object, or bringing the object to a location.
17. The method of any of clauses 12-16, wherein the performing the one or more operations to train the plurality of machine learning models comprises performing one or more operations to train a fourth machine learning model included in the plurality of machine learning models, and performing one or more operations to train a fifth machine learning model included in the plurality of machine learning models, wherein the one or more operations to train the fourth machine learning model begin at a different time than the one or more operations to train the fifth machine learning model.
18. In some embodiments, a system comprises one or more processors to control at least a portion of a robot using a machine learning model trained based at least on one or more population-based training operations and one or more reinforcement learning operations.
19. The system of clause 18, wherein the machine learning was trained by performing operations that comprise updating at least one first value of at least one first parameter or at least one first hyperparameter associated with one or more first machine learning models included in a plurality of machine learning models based at least on at least one second value of at least one second parameter or at least one second hyperparameter associated with one or more second machine learning models included in the plurality of machine learning models.
20. The system of clauses 18 or 19, wherein the one or more processors control at least the portion of the robot to at least one of reach an object, pick up the object, manipulate the object, move the object, or move within an environment.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A method comprising:
performing one or more operations to train a plurality of machine learning models to control at least a portion of a robot to perform a task;
updating at least one first value of at least one parameter or at least one hyperparameter associated with one or more first machine learning models included in the plurality of machine learning models based at least on at least one second value of the at least one parameter or the at least one hyperparameter associated with one or more second machine learning models included in the plurality of machine learning models; and
subsequent to the updating, performing one or more additional operations to train the plurality of machine learning models to control at least the portion of the robot to perform the task.

2. The method of claim 1, wherein the one or more first machine learning models include a predefined percentage of worst performing machine learning models in the plurality of machine learning models, and the one or more second machine learning models include a predefined percentage of best performing machine learning models in the plurality of machine learning model.

3. The method of claim 1, wherein the one or more first machine learning models include a predefined percentage of machine learning models in the plurality of machine learning models whose performance is neither worst nor best in the plurality of machine learning models, and the one or more first machine learning models include a predefined percentage of best performing machine learning models in the plurality of machine learning models.

4. The method of claim 1, wherein the updating the at least one first value of the at least one parameter or the at least one hyperparameter associated with the one or more first machine learning models comprises replacing the at least one value of the at least one parameter or the at least one hyperparameter associated with the one or more first machine learning models with the at least one second value of the at least one parameter or the at least one hyperparameter associated with the one or more second machine learning models.

5. The method of claim 1, wherein the one or more operations to train the plurality of machine learning models comprise one or more reinforcement learning operations.

6. The method of claim 1, wherein the one or more operations to train the plurality of machine learning models are based at least on a reward associated with at least one of reaching an object, picking up the object, or bringing the object to a location.

7. The method of claim 1, wherein the one or more operations to train the plurality of machine learning models are based at least on meta-optimization of an objective.

8. The method of claim 1, wherein the performing the one or more operations to train the plurality of machine learning models comprises:
performing one or more operations to train a third machine learning model included in the plurality of machine learning models; and
performing one or more operations to train a fourth machine learning model included in the plurality of machine learning models,
wherein the one or more operations to train the third machine learning model begin at a different time than the one or more operations to train the fourth machine learning model.

9. The method of claim 1, further comprising, subsequent to the performing the one or more additional operations:
selecting a third machine learning model included in the plurality of machine learning models based on a performance of the third machine learning model; and
performing one or more operations to control at least the portion of the robot to perform the task using the third machine learning model.

10. The method of claim 1, wherein the task includes at least one of regrasping an object, throwing an object, or reorienting an object with one or two arms of the robot.

11. The method of claim 1, wherein the method is performed by a processor comprised in at least one of:
an infotainment system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using the robot;
a system for generating or presenting virtual reality, augmented reality, or mixed reality content;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.

12. A method comprising:
receiving sensor data associated with a robot;
generating an action based at least on the sensor data and a first machine learning model; and
controlling at least a portion of the robot to perform a task based on the action,
wherein the first machine learning model was trained by:
performing one or more operations to train a plurality of machine learning models to control at least the portion of the robot to perform the task,
updating at least one first value of at least one parameter or at least one hyperparameter associated with one or more second machine learning models included in the plurality of machine learning models based at least on at least one second value of the at least one parameter or the at least one hyperparameter associated with one or more third machine learning models included in the plurality of machine learning models,
subsequent to the updating, performing one or more additional operations to train the plurality of machine learning models to control at least the portion of the robot to perform the task, and
selecting the first machine learning model from the plurality of machine learning models.

13. The method of claim 12, wherein the one or more second machine learning models include a predefined percentage of worst performing machine learning models in the plurality of machine learning models, and the one or more third machine learning models include a predefined percentage of best performing machine learning models in the plurality of machine learning models.

14. The method of claim 12, wherein the one or more operations to train the plurality of machine learning models comprise one or more reinforcement learning operations.

15. The method of claim 12, wherein the performing the one or more operations to train the plurality of machine learning models comprises performing one or more operations to simulate the robot in a plurality of simulations, and the plurality of simulations are performed in parallel via one or more graphics processing units (GPUs).

16. The method of claim 12, wherein the one or more operations to train the plurality of machine learning models are based at least on at least one of meta-optimization of an objective or optimization of a reward associated with at least one of reaching an object, picking up the object, or bringing the object to a location.

17. The method of claim 12, wherein the performing the one or more operations to train the plurality of machine learning models comprises:
performing one or more operations to train a fourth machine learning model included in the plurality of machine learning models; and
performing one or more operations to train a fifth machine learning model included in the plurality of machine learning models,
wherein the one or more operations to train the fourth machine learning model begin at a different time than the one or more operations to train the fifth machine learning model.

18. A system comprising:
one or more processors to control at least a portion of a robot using a machine learning model trained based at least on one or more population-based training operations and one or more reinforcement learning operations.

19. The system of claim 18, wherein the machine learning was trained by performing operations that comprise updating at least one first value of at least one first parameter or at least one first hyperparameter associated with one or more first machine learning models included in a plurality of machine learning models based at least on at least one second value of at least one second parameter or at least one second hyperparameter associated with one or more second machine learning models included in the plurality of machine learning models.

20. The system of claim 18, wherein the one or more processors control at least the portion of the robot to at least one of reach an object, pick up the object, manipulate the object, move the object, or move within an environment.
